(19) United States
(12) Patent Application Publication
(10) Pub. No.: US 2016/0265410 A1
(43) Pub. Date: Sep. 15, 2016

(54) EXHAUST HEAT RECOVERY AND STORAGE SYSTEM

(71) Applicant: BorgWarner Inc., Auburn Hills, MI (US)

(72) Inventors: Steven Myers, Oxford, MI (US); Andrew Sutherland, Birmingham, MI (US); Jim Ignatovich, Ceresco, MI (US); Jon Stagg, Bellevue, MI (US); Mark Ventimiglia, Sterling Heights, MI (US)

(21) Appl. No.: 14/643,582

(22) Filed: Mar. 10, 2015

(51) Int. Cl. F01N 5/02; B23P 15/26; F28D 20/02

(52) U.S. Cl. CPC F01N 5/02; F28D 20/02; B23P 15/26; F28D 20/021

(57) ABSTRACT

A product is disclosed for recovering heat and may include a housing with two flow paths defined through the housing. A number of tube assemblies may be disposed in the housing. The tube assemblies may comprise an inner tube and an outer tube with a space defined between the inner tube and the outer tube. One flow path may be defined through the inner tubes, and the other flow path may be defined outside the outer tubes. A phase change material may be disposed in the spaces of the tube assemblies. The phase change material may change phases when exposed to a temperature change.

### TECHNICAL FIELD

The field to which the disclosure generally relates includes heat recovery and storage systems.

### BACKGROUND

In operation many systems, particularly those in vehicles with internal combustion engines, produce excess heat that is typically dissipated to the atmosphere through cooling systems. These same systems, along with other systems typically found in vehicles, could benefit from additional heating under other circumstances such as a cold start. If available, the additional heating could shorten the interval during which a system reaches a preferred operating temperature.

### SUMMARY OF ILLUSTRATIVE VARIATIONS

A number of variations may involve a product for recovering heat. A housing may include two flow paths that are defined through the housing. A number of tube assemblies may be disposed in the housing. The tube assemblies may comprise an inner tube and an outer tube with a space defined between the inner tube and the outer tube. One flow path may be defined through the inner tubes, and the other flow path may be defined outside the outer tubes. A phase change material may be disposed in the spaces of the tube assemblies. The phase change material may change phases when exposed to a temperature change to alternately store and release heat.

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is an isometric view of an exhaust heat recovery and storage system according to a number of variations.

FIG. 2 is an isometric view of the exhaust heat recovery and storage system of FIG. 1 with part of its housing removed to expose the interior.

FIG. 3 is a schematic illustration of part of an exhaust heat recovery and storage system arrangement according to a number of variations.

FIG. 4 is a schematic illustration of part of an exhaust heat recovery and storage system arrangement according to a number of variations.

FIG. 5 is a schematic illustration of part of an exhaust heat recovery and storage system arrangement according to a number of variations.

FIG. 6 is a bundle plate diagram showing a tube matrix for an exhaust heat recovery and storage system arrangement according to a number of variations.

FIG. 7 is a bundle plate diagram showing a tube matrix for an exhaust heat recovery and storage system arrangement according to a number of variations.

FIG. 8 is a bundle plate diagram showing a tube matrix for an exhaust heat recovery and storage system arrangement according to a number of variations.

### DETAILED DESCRIPTION OF ILLUSTRATIVE VARIATIONS

The following description of the variations is merely illustrative in nature and is in no way intended to limit the scope of the invention, its application, or uses.

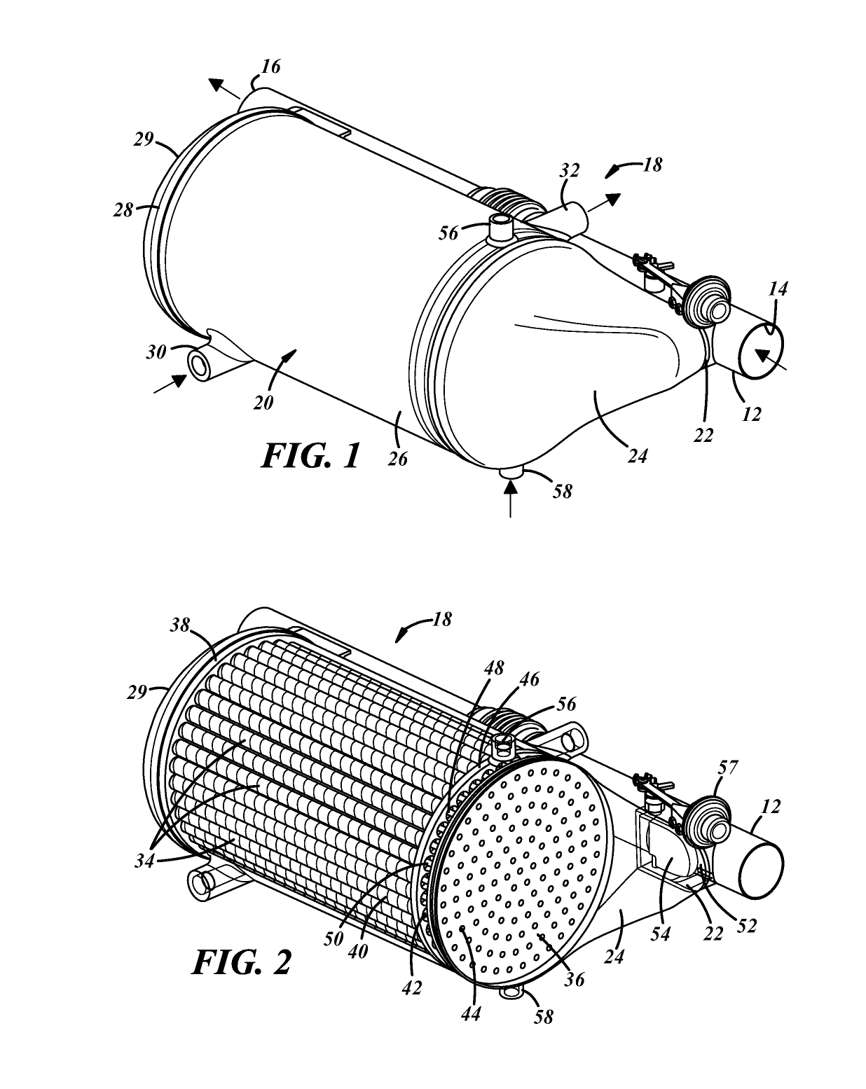

In a vehicle with an internal combustion engine, combustion byproducts may be directed through an exhaust system that may include a fluid conduit 12 for channeling the exhaust gases as shown in FIG. 1 for a number of variations. The illustrated fluid conduit 12 may comprise a segment of the exhaust system with an inlet 14 receiving gases from the internal combustion engine and an outlet 16 directing gases through the remainder of the exhaust system. The segment comprising fluid conduit 12 may be unobstructed in its normal state so that exhaust gasses may pass freely through. A heat exchanger assembly 18 may be positioned adjacent the fluid conduit 12 and may include a housing 20 with an inlet 22 connected to the wall of the fluid conduit 12 for selectively receiving exhaust gases from the fluid conduit 12.

The housing 20 may include a collector section 24 that expands flow from the cross section at inlet 22 to the main chamber section 26. The end 28 of the main chamber section 26 may include a collector section 29 that may include a reducing cross section from the main chamber section 26 to a return connection to the fluid conduit 12. The main chamber section 26 may include a working fluid inlet 30 and a working fluid outlet 32 for channeling a working fluid through the interior of the main chamber section 26. The working fluid may be a fluid in gas or liquid state that provides a function for a vehicle system including but not limited to: engine coolant, engine oil, transmission fluid, fuel, diesel exhaust fluid, vehicle hydraulic fluid, air, and other fluids. The heat exchanger 18 may provide a mechanism to selectively extract heat energy from the exhaust gas stream for use in heating the selected working fluid for pre-heating, additional heating, or accelerated heating. Heating may be beneficial for emission control, passenger comfort, defrosting, system performance, and other results.

Referring to FIG. 2, the heat exchanger 18 of FIG. 1 is illustrated with part of the housing wall removed. The heat exchanger 18 may include a number of tube assemblies 34 that may extend between a first bundle plate 36 and a second bundle plate 38. Each tube assembly 34 may include an outer tube 40 with an inner tube 42 extending through the outer tube 40. Each inner tube 42 may register with an opening 44 in the bundle plate 36, and a corresponding opening in the bundle plate 38 so that fluid directed into the collector section 24 may be directed through the inner tubes and into the collector section 29 for return to the fluid conduit 12. While the tube assemblies 34 are illustrated as having a round cross section, other tube shapes may be used. For example, wavy tubes, rolled groove tubes, spiral tubes, axial finned tubes, or other shapes may be used.

A separator plate 46 may be positioned inside the housing 20 and spaced apart from the bundle plate 36, which may include the openings 44 corresponding to each inner tube 42. The inner tubes 42 may pass through the separator plate 46 for connection to the bundle plate 36. The separator plate 44 and the bundle plate 36 may define a header 48 space. The separator plate 46 may include a number of openings 50 each corresponding to a tube assembly 34. Each inner tube 42 may pass through the openings 50 with clearance and each outer tube 40 may register with an opening 50 and may be connected to the separator plate 46. The inside of the outer tubes 40 may be open to the header 48 so that the space between the inner tubes 42 and the outer tubes 40 may be in communication with the space of the header 48. At the opposite end, the outer tubes 40 may be sealed against the header 38 to create blind ends of the annular spaces between the inner tubes 42 and the outer tubes 40. The housing 20 may include a pair of connection points providing ports 56 and 58 that open into the header 48. The fluid conduit 12 may include an opening 52 that registers with the inlet section 22. The opening may be closed by a diverter door 54 that may be selectively opened through operation of an actuator 57 to admit exhaust gas into the collector section 24, and there through, further into the heat exchanger 18.

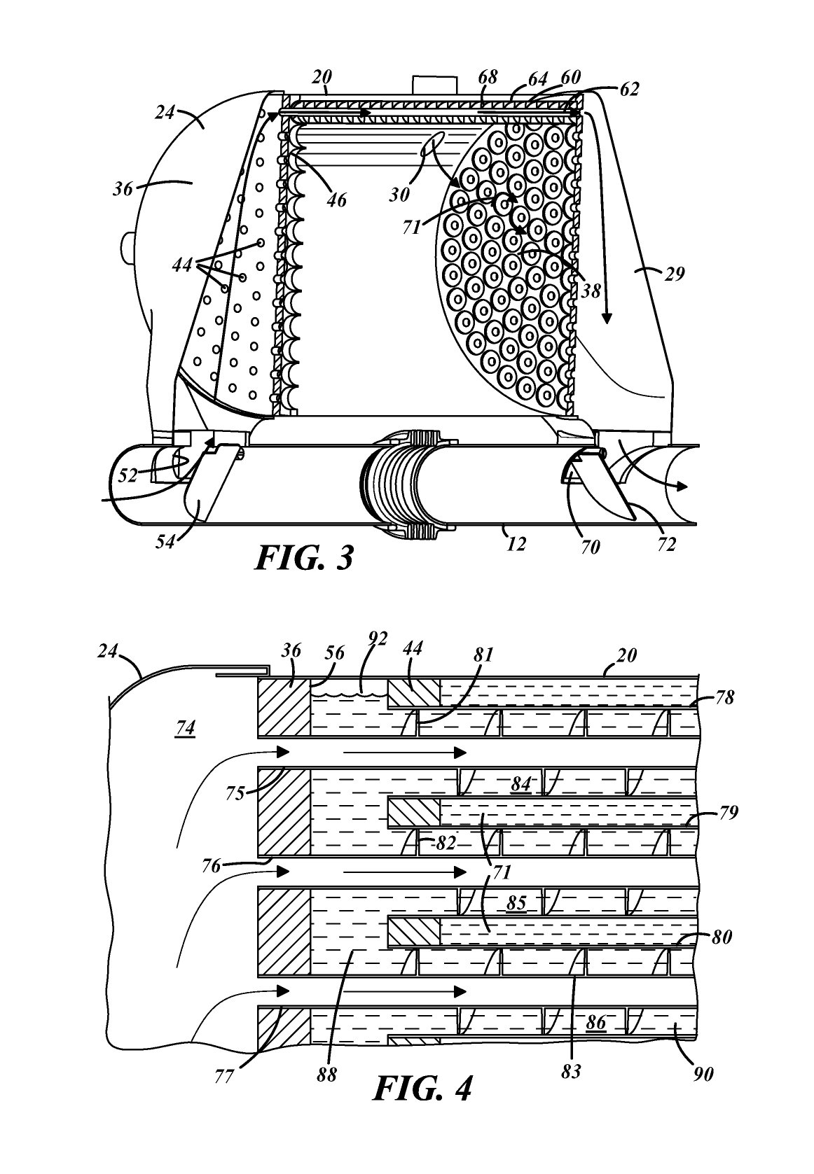

Referring to FIG. 3, a number of variations are illustrated in schematic form showing exhaust gas flow diverted into the housing 20, which corresponds to a charging operation of the heat exchanger. A representative tube assembly 60 is shown extending between the bundle plate 36 and the bundle plate 38. The tube assembly 60 may include an inner tube 62 and an outer tube 64, with an annular space 68 defined between the inner tube 62 and the outer tube 64. The annular space 68 may extend from the separator plate 46 to the bundle plate 38. The fluid conduit 12 may include the opening 52 and another opening 70, each in communication with the inside of the heat exchanger 18 at the collector section 24 and the collector section 29, respectively. The diverter door 70 may be driven to extend into the fluid conduit 12 of the exhaust pipe to obstruct flow there through and to assist in diverting flow into the collector section 24. In collector section 24, exhaust gas may be distributed to the inner tubes through the openings 44 in the bundle plate 36. Exhaust gas may pass through the inner tubes, including inner tube 62 and may be discharged into the collector section 29 within which flow is aggregated and directed through the opening 70. The opening 70 may be normally closed by an outlet door 72 to prevent backflow. The outlet door 72 may open under the force of fluid flow out of the collector section 29, or may be connected to an actuator for selective control. Through the opening 70, exhaust gas may reenter the exhaust system and be carried downstream. Working fluid may enter the housing 20 at the port 30 and may flow around the outside of the outer tubes to collect heat as indicated at reference numeral 71.

FIG. 4 illustrates a number of variations in schematic form. The housing 20 may include the main chamber section 26 and the collector section 24. The bundle plate 36 may extend across the main chamber section 26 to separate out the area of the collector 74. The inner tubes 75, 76 and 77 may be connected to the bundle plate 36 so that their interiors are open to the collector 74. Each inner tube 75, 76 and 77 may be surrounded by a corresponding outer tube 78, 79, 80. Each inner tube 75, 76 and 77 may have an extending fin 81, 82 and 83 extending from its outer surface that may spiral around the respective inner tube and may extend along a length of the inner tube. The fins 81, 82 and 83 may have outer peripheries that connect with the outer tubes 78, 79 and 80 to provide a conductive heat transfer path between the inner and outer tubes. The fins 81, 82 and 83 may define continuous spiral spaces 84, 85 and 86 between the inner and outer tubes that extend along the length of the outer tubes 78, 79 and 80 and that are open to the header 48. The fins may be singular or plural, and may alternatively be spiral, axial straight, perforated, or of another configuration or combination of configurations.

The spaces 84, 85 and 86 may be filled with a heat storage medium such as a phase change material 90. The phase change material 90 may be selected for its ability undergo an exothermic process to absorb and store heat energy and to release the stored heat energy. Examples of a suitable material for the phase change material 90 may include hydrated salts or other commercially available alternatives. The header 48 and the spaces 84, 85, 86 may be filled when the phase change material 90 is in a liquid state. Accordingly, the heat exchanger may be assembled and then heated. The phase change material 90 may also be heated to its liquid state and introduced into the header 74 through the port 56. In a liquid state, the phase change material 90 may readily move into the spaces 84, 85 and 86. The header 48 may be filled but leaving a void 92 to accommodate expansion of the phase change material 90. The combination of ports 56 and 58 (shown in FIG. 1), provide a means of filling and bleeding the header 48.

During a heating or charging process of the phase change material 90, exhaust gases may be diverted into the collector 74 and through the flow path defined by the inner tubes 75, 76 and 77. Heat may transfer through the wall of the inner tubes and the fins 81, 82 and 83 and may be absorbed by the phase change material 90. The phase change material 90 may be heated above its phase change temperature and may exist in liquid state (or in other variations in a gas state). An insulation material layer 91 may be provided on the outside of the housing 20 to help maintain stored latent heat in the phase change material 90. The length and overall diameter of the heat exchanger 18, along with the cross section of the tube assemblies may be selected to ensure the latent heat storage capacity is sufficient for the intended application, and to minimize thermal inertia so that the device may be charged in an acceptable timeframe.

The stored latent heat may be used to heat the working fluid by flowing it in through the inlet 30 (shown in FIG. 1), so that it is distributed through the flow path 71 including spaces around the outside of the outer tubes 78, 79, 80. Heat may be conducted from the phase change material 90 through the outer tube walls to the working fluid. As heat is extracted, the phase change temperature of the phase change material 90 may be reached at which point a rapid release of heat may occur and is available for quickly heating the working fluid. Heat may be extracted solely from the phase change material 90 or may be supplemented with heat from the exhaust gas stream. In the supplemented mode of operation, stored heat energy from the phase change material 90 may be transferred to the working fluid. In addition, exhaust gas may be simultaneously diverted through the inner tubes 75, 76, 77 and heat may be conducted through the wall of the inner tubes, the fins, 81, 82, 83 and the wall of the outer tubes 78, 79, 80, and then transferred to the working fluid. Mechanical boosting of the conduction heat exchange via conduction through the fins 81, 82, 83, may increase efficiency as opposed to conduction through the phase change material 90 alone. The dual mode heat source option provides additional heat and may allow reduction in the overall size of the heat exchanger for the selected application.

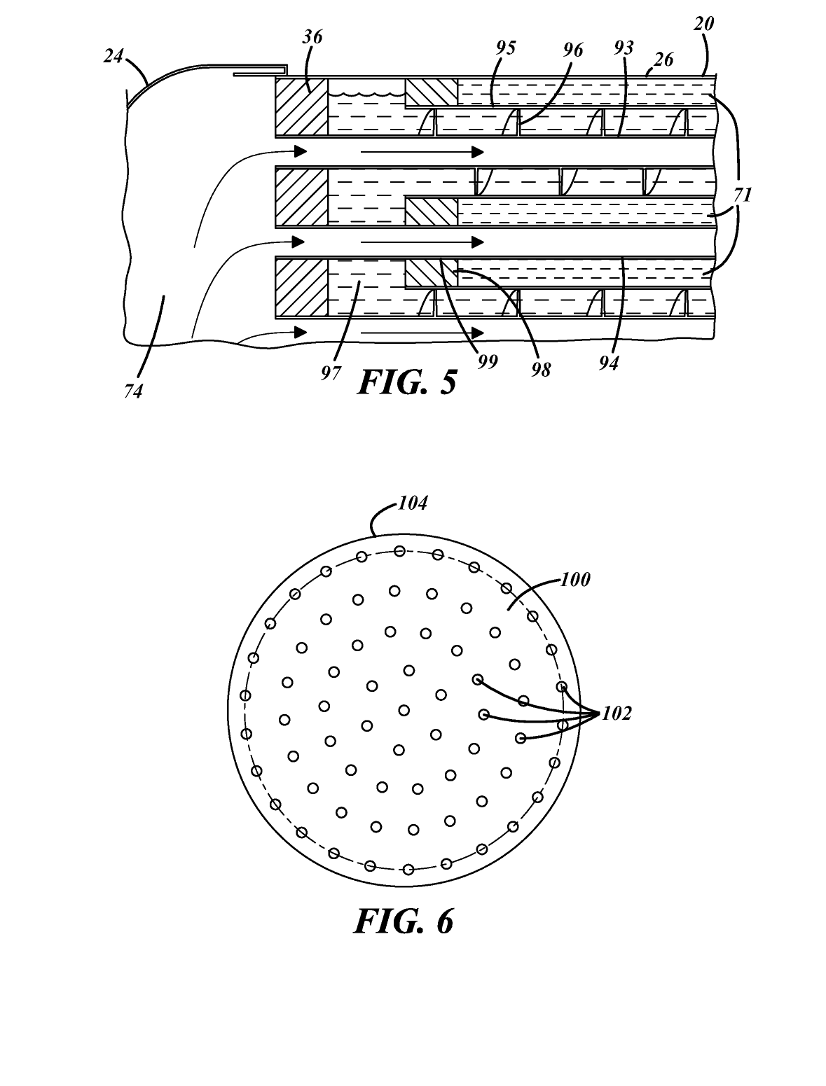

Referring to FIG. 5, a number of additional variations are illustrated in schematic form. The housing 20 may include the main chamber section 26 and the collector section 24. The bundle plate 36 may extend across the main chamber section 26 to separate out the collector 74. A number of tubes including the inner tube 93 and an individual tube 94 may be connected to the bundle plate 36 so that their interiors are open to the collector 74. The inner tube 93 may be surrounded by a corresponding outer tube 95. The inner tube 93 may have a fin 96 extending from its outer surface that spirals around the inner tube 93 and extends along at least part of its length. The fin 96 may have outer periphery that connects with the outer tube 95 to provide a conductive heat transfer path between the inner and outer tubes. The fin 96 may define a continuous spiral space between the inner and outer tubes that extends along the length of the outer tube 95 and that is open to a header 97. The individual tube 94 may extend through the separator plate 98 with a sealed interface 99. The wall of the individual tube 94 may be in direct contact with the working fluid in the flow path 71. The number of individual tubes such as tube 94 in the heat exchanger may be selected so that the phase change material in the remaining tube assemblies may act as a thermal energy storage buffer to negate thermal transience while still providing sufficient heat extraction storage and reuse. Optionally, the spaces in the tube assemblies may not be completely filled with phase change material but may instead contain a reduced quantity. The selected balance may enable faster exhaust sourced energy transfer to the working fluid with lower thermal inertia.

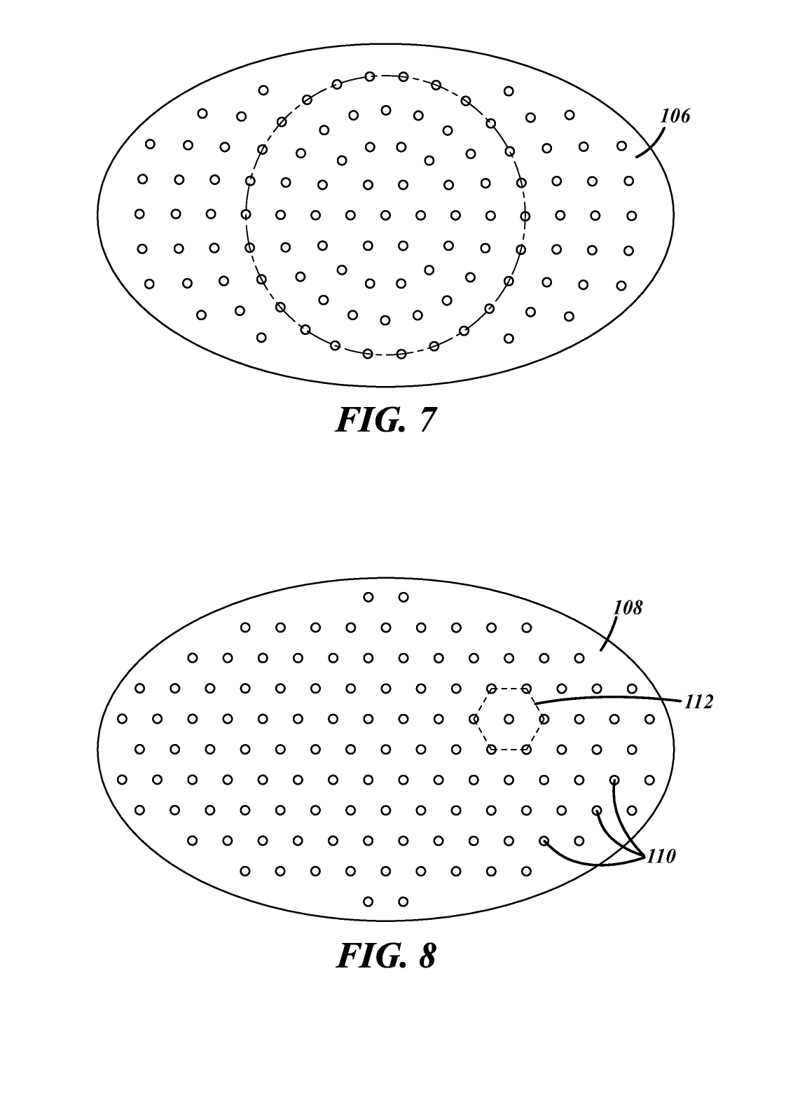

Referring to FIG. 6, a tube position matrix according to a number of variations is illustrated with reference to a bundle plate 100. For packing efficiency, a concentric circular arrangement may be used for the inner tube locations represented by the locations 102. The matrix properties may be chosen for packing efficiency to reduce the overall size of the heat exchanger and to minimize the volume of working fluid needed to fill the flow path around the outside of the tubes. This may minimize thermal inertia and support more rapid heating. The outer periphery 104 of the device may be chosen to fit in the available packaging space, which is circular in the case of the arrangement shown in FIG. 6. The profile of the device may be reduced in one direction such as the elliptical shape of the bundle plate 106 shown in FIG. 7, to fit constrained space availability. The matrix may be a circular pattern as shown in FIG. 7 or may be an alternating pattern as shown in the bundle plate 108 of FIG. 8. The matrix of the inner tubes 110 may be hexagonal as indicated at matrix segment 112 for efficient packing.

Through the forgoing variations, a number of efficient structures and methods are described for recovering waste heat in a product with a plurality of nested tubes at least some of which may contain a thermal energy storage material that may operate using the latent heat of fusion. A working fluid may be heated by using the stored latent heat or in a mode using both the stored latent heat and conductive heat transfer. The stored heat may be available upon a cold start wherein vehicle system operating temperatures may otherwise be below ideal operating temperatures. The following description of variants is only illustrative of components, elements, acts, products and methods considered to be within the scope of the invention and is not in any way intended to limit such scope by what is specifically disclosed or not expressly set forth. Components, elements, acts, products and methods may be combined and rearranged other than as expressly described herein and still considered to be within the scope of the invention.

Variation 1 may include a product for recovering heat and may include a housing with a first flow path defined through the housing and a second flow path defined through the housing. At least one tube assembly may be disposed in the housing. The tube assembly or assemblies may include an inner tube and an outer tube with a space defined between the inner tube and the outer tube. The first flow path may be defined through the inner tube, and the second flow path may be defined outside the outer tube. A heat storage medium may be disposed in the space and may be adapted to store and release heat.

Variation 2 may include a product according to variation 1 wherein the first flow path may carry a first fluid and the second flow path may carry a second fluid. The heat storage medium may change phases when exposed to a temperature change and may store heat from the first fluid and may release heat to the second fluid.

Variation 3 may include a product according to variation 1 or 2 and may include a header defined in the housing. The space may be open to the header and the heat storage medium may also disposed in the header.

Variation 4 may include a product according to variation 3 wherein the header includes avoid to accommodate an expansion of the heat storage medium.

Variation 5 may include a product according to any of variations 1 through 4 and may include a fin extending along the tube assembly between the inner tube and the outer tube. The fin may have a length from a first end of the outer tube to a second end of the outer tube. The fin may contact both the inner tube and the outer tube along the length.

Variation 6 may include a product according to variation 5 wherein the fin may spiral along the length.

Variation 7 may include a product according to any of variations 2 through 6 and may include a set of individual tubes extending through the housing. Each tube in the set of individual tubes may include a tube wall with an inner surface and an outer surface. The first fluid may contact the inner surface and the second fluid may contact the outer surface.

Variation 8 may include a product for recovering heat and may include a fluid conductor having a first opening and a second opening. A housing may be disposed near the fluid conductor. An interior of the housing may be open to the fluid conductor through the first opening and the second opening. A diverter door may selectively open and close the first opening. The diverter door may obstruct flow through the fluid conductor when opening the first opening. A plurality of tube assemblies may be disposed in the housing, each comprising an inner tube and an outer tube. The inner tube may extend through the outer tube to define a space between the inner tube and the outer tube. The inner tube having a first end and a second end. A first collector may be defined in the housing. The inner tubes may be open to the first collector at their first ends. The first opening may open to the first collector. A second collector may be defined in the housing. The inner tubes may open to the second collector at their second ends. The second opening may open to the second collector. A first flow path may extend from the fluid conductor into the housing and through the first opening, the first collector, the inner tubes, the second collector and then back into the fluid conductor through the second opening. A fluid inlet and a fluid outlet may each open into the housing. A second flow path may be defined through the housing from the fluid inlet to the fluid outlet. The second flow path may be directed around the outer tubes. A phase change material may be disposed in the spaces of the tube assemblies, the phase change material changing from a first phase to a second phase when exposed to a temperature change.

Variation 9 may include a product according to variation 8 and may include a header defined in the housing. The spaces may be open to the header and the phase change material may also be disposed in the header.

Variation 10 may include a product according to variation 9 wherein the header may include a void to accommodate an expansion of the phase change material.

Variation 11 may include a product according to variation 8 or 9 and may include a fin extending along each tube assembly between the inner tube and the outer tube. The fin may have a length from a first end of the outer tube to a second end of the outer tube. The fin may contact the inner tube and the outer tube along the length.

Variation 12 may include a product according to variation 11 wherein the fin may spiral along the length.

Variation 13 may include a product according to any of variations 8 through 12 and may include a set of individual tubes extending through the housing. Each individual tube may include a tube wall with an inner surface and an outer surface. The first flow path may be adjacent the inner surface and the second flow path may be adjacent the outer surface.

Variation 14 may include a product according to any of variations 8 through 13 wherein the fluid conductor in an exhaust pipe of a vehicle.

Variation 15 may include a product according to any of variations 8 through 14 wherein the second flow path may carry a working fluid of the vehicle.

Variation 16 may include method of making an exhaust heat recovery system. A set of tube assemblies may be provided wherein each tube assembly has an outer tube and an inner tube. One of the inner tubes may be inserted through each of the outer tubes to define a space between each inner tube and its respective outer tube. Each inner tube may have a first end disposed outside its respective outer tube and a second end disposed outside its respective outer tube. A first bundle plate may be connected to the first ends of the inner tubes. A second bundle plate may be connected to the second ends of the inner tubes. A housing may be assembled around the set of tube assemblies so that a first collector volume is defined between the housing and the first bundle plate and a second collector volume is defined between the housing and the second bundle plate. A header may be provided in the housing, the header open to the spaces. The housing and the tube assemblies may be heated. A phase change material may be provided and heated to a temperature that converts the phase change material to a liquid. The phase change material may be introduced, in liquid phase, into the header so that it disperses through the spaces.

Variation 17 may include a method according to variation 16 wherein fins may be added to the set of tube assemblies. Each fin may extend between the inner tube and its respective outer tube.

Variation 18 may include a method according to variation 17 and may include the step of spiraling the fins along a length of the inner tubes.

Variation 19 may include a method according to variation 17 or 18 and may include the step of crimping each outer tube around the fins in a spiral.

Variation 20 may include a method according to any of variations 16 through 19 and may include the step of connecting the housing to an exhaust pipe with a first opening between the exhaust pipe and the housing and a second opening between the exhaust pipe and the housing.

The above description of select variations within the scope of the invention is merely illustrative in nature and, thus, variations or variants thereof are not to be regarded as a departure from the spirit and scope of the invention.

1. A product for recovering heat comprising:
a housing with a first flow path defined through the housing and a second flow path defined through the housing;
at least one tube assembly disposed in the housing, the at least one tube assembly comprising an inner tube and an outer tube with a space defined between the inner tube and the outer tube, wherein the first flow path is defined through the inner tube, and the second flow path is defined outside the outer tube,
a heat storage medium disposed in the space, the heat storage medium adapted to store and release heat,
a first collector section of the housing with an expanding area of the first flow path that expands the first flow path from an inlet disposed perpendicular to the at least one tube,
a second collector section with a reducing area of the first flow path that reduces the first flow path to an outlet disposed perpendicular to the at least one tube, and
a straight section of fluid conduit having a first opening and a second opening, the inlet connected with the straight section of fluid conduit at the first opening and the outlet connected with the straight section of fluid conduit at the second opening.

2. The product according to claim 1 wherein the first flow path carries a first fluid and the second flow path carries a second fluid and wherein the heat storage medium changing phases when exposed to a temperature change and stores heat from the first fluid and releases heat to the second fluid.

3. The product according to claim 1 further comprising a header defined in the housing wherein the space is open to the header and wherein the heat storage medium is also disposed in the header.

4. The product according to claim 3 wherein the header includes a void to accommodate an expansion of the heat storage medium.

5. The product according to claim 1 further comprising a fin extending along the tube assembly between the inner tube and the outer tube the fin having a length from a first end of the outer tube to a second end of the outer tube, the fin contacting both the inner tube and the outer tube along the length.

6. The product according to claim 5 wherein the fin comprises a singular plate extending between the inner tube and the outer tube that spirals along the length.

7. The product according to claim 2 further comprising a set of individual tubes extending through the housing wherein each tube in the set of individual tubes includes a tube wall with an inner surface and an outer surface and wherein the first fluid contacts the inner surface and the second fluid contacts the outer surface.

8. A product for recovering heat in a vehicle comprising:
a fluid conductor having a first opening and a second opening;
a housing disposed near the fluid conductor, an interior of the housing open to the fluid conductor through the first opening and the second opening;
a diverter door selectively opening and closing the first opening, the diverter door extending into and obstructing flow through the fluid conductor when opening the first opening;
a plurality of tube assemblies disposed in the housing, each tube assembly in the plurality of tube assemblies comprising an inner tube and an outer tube, the inner tube extending through the outer tube to define a space between the inner tube and the outer tube, the inner tube having a first end and a second end;
a first collector defined in the housing, wherein the inner tubes open to the first collector at their first ends, and wherein the first opening opens to the first collector;
a second collector defined in the housing, wherein the inner tubes open to the second collector at their second ends, and wherein the second opening opens to the second collector;
wherein a first flow path extends from the fluid conductor into the housing and through the first opening, the first collector, the inner tubes, the second collector and then back into the fluid conductor through the second opening;
a fluid inlet and a fluid outlet opening into the housing, wherein a second flow path is defined through the housing from the fluid inlet to the fluid outlet, the second flow path directed around the outer tubes;
a phase change material disposed in the spaces of the tube assemblies, the phase change material changing from a first phase to a second phase when exposed to a temperature change wherein the fluid conductor is an exhaust pipe of the vehicle.

9. The product according to claim 8 further comprising a header defined in the housing wherein the spaces are open to the header and wherein the phase change material is also disposed in the header.

10. The product according to claim 9 wherein the header includes a void to accommodate an expansion of the phase change material.

11. The product according to claim 8 further comprising a fin extending along each tube assembly between the inner tube and the outer tube, the fin having a length from a first end of the outer tube to a second end of the outer tube, the fin contacting the inner tube and the outer tube along the length.

12. The product according to claim 11 wherein the fin spirals along the length.

13. The product according to claim 8 further comprising a set of individual tubes extending through the housing wherein each tube in the set of individual tubes includes a tube wall with an inner surface and an outer surface and wherein the first flow path is adjacent the inner surface and the second flow path is adjacent the outer surface.

14. (canceled)

15. The product according to claim 8 wherein the second flow path carries a working fluid of the vehicle.

16. A method of making the product defined by claim 8 comprising the steps of:
a. inserting one of the inner tubes through each of the outer tubes to define a space between each inner tube and its respective outer tube, wherein each inner tube has its first end disposed outside its respective outer tube and has its second end disposed outside its respective outer tube;
b. connecting a first bundle plate to the first ends of the inner tubes;
c. connecting a second bundle plate to the second ends of the inner tubes;
d. assembling the housing around the plurality of tube assemblies so that a first collector volume is defined between the housing and the first bundle plate and a second collector volume is defined between the housing and the second bundle plate;
f. providing a header in the housing, the header open to the spaces;
g. heating the housing and the tube assemblies;
h. heating the phase change material to a temperature that converts the phase change material to a liquid; and
i. introducing the phase change material in liquid phase into the header so that it disperses through the spaces.

17. The method according to claim 16 further comprising the step of adding fins to the set of tube assemblies wherein each fin extends between the inner tube and its respective outer tube.

18. The method according to claim 17 further comprising the step of spiraling the fins along a length of the inner tubes.

19. The method according to claim 17 further comprising the step of crimping each outer tube around the fins in a spiral.

20. The method according to claim 16 further comprising the step of connecting the housing to the exhaust pipe with a first opening between the exhaust pipe and the housing and a second opening between the exhaust pipe and the housing.

21. The product according to claim 9 wherein a first port opens to the header and a second port opens to the header on an opposite side of the housing from the first port, and the second port is across the plurality of tube assemblies from the first port.

22. A product for recovering heat from a vehicle comprising:
a housing with a first flow path defined through the housing and a second flow path defined through the housing,
at least one tube assembly disposed in the housing, the at least one tube assembly comprising an inner tube and an outer tube with a space defined between the inner tube and the outer tube, wherein the first flow path is defined through the inner tube, and the second flow path is defined outside the outer tube,
a heat storage medium disposed in the space, the heat storage medium adapted to store and release heat,
an exhaust pipe of the vehicle wherein the first flow path is selectively connected with the exhaust pipe through a diverter door, the diverter door extending into the exhaust pipe diverting exhaust into the first flow path and restricting flow through the exhaust pipe.

23. The product according to claim 22 further comprising a second diverter door disposed in the first flow path, the second diverter door opening the first flow path to return to the exhaust pipe by extending into the exhaust pipe.

24. The product according to claim 22 further comprising a fin that comprises a singular spiraling extension between the inner tube and the outer tube defining a spiraling unitary space between the tubes.

25. The product according to claim 24 further comprising a crimp in the outer tube in a spiral that secures the fin to the outer tube.

26. The product according to claim 24 further comprising a first bundle plate connected to a first end of the inner tube and a second bundle plate connected to an opposite second end of the inner tube wherein the fin extends completely between the first and second bundle plates.

27. the product according to claim 22 further comprising a first bundle plate separating a first collector section in the housing, the first bundle plate connected to a first end of the inner tube, a second bundle plate separating a second collector section in the housing, the second bundle plate connected to an opposite second end of the inner tube, a separator plate extending within the housing and separating a header in the housing, the inner tube extending through an opening in the separator plate, the space open to the header through the opening.

28. The product according to claim 27 wherein the housing defines a first port that opens to the header.

29. The product according to claim 28 wherein the housing defines a second port that opens to the header opposite the first port.

30. The product according to claim 8 wherein the plurality of tube assemblies are arranged in a tube position matrix comprising a series of at least three concentric circles.
